(19) United States
(12) Patent Application Publication
(10) Pub. No.: US 2012/0189364 A1
(43) Pub. Date: Jul. 26, 2012

(54) REDUCING DRAG ON ROTATABLE WEB DRIVE MEMBER

(76) Inventors: Andrew Peter Kittleson, Rochester, NY (US); Timothy John Young, Williamson, NY (US)

(21) Appl. No.: 13/011,074

(22) Filed: Jan. 21, 2011

(51) Int. Cl. G03G 15/00; B65G 23/44

(52) U.S. Cl. 399/361; 198/813

(57) ABSTRACT

A method of reducing drag on a rotatable web drive member for driving a web in an electrophotographic printer includes spacing a plurality of rotatable, driven tensioning members, divided into two groups, along the web. Each tensioning member exerts a respective drag force on the web drive member through the web while maintaining tension on the web between adjacent members, and has a surface speed at a point of contact with the web. Each tensioning member in the first group is rotated with a greater surface speed than each member in the second group. Members of the first group thus exert a negative drag (overdrive) and members of the second group exert a positive drag (underdrive), and the total drag on the web drive member is less than the sum of the magnitudes of the respective drags exerted by the tensioning members.

### FIELD OF THE INVENTION

This invention pertains to the field of electrophotographic printing and more particularly to driving webs in electrophotographic printers.

### BACKGROUND OF THE INVENTION

Electrophotography is a useful process for printing images on a receiver (or “imaging substrate”), such as a piece or sheet of paper or another planar medium, glass, fabric, metal, or other objects as will be described below. In this process, an electrostatic latent image is formed on a photoreceptor by uniformly charging the photoreceptor and then discharging selected areas of the uniform charge to yield an electrostatic charge pattern corresponding to the desired image (a “latent image”).

After the latent image is formed, charged toner particles are brought into the vicinity of the photoreceptor and are attracted to the latent image to develop the latent image into a visible image. Note that the visible image may not be visible to the naked eye depending on the composition of the toner particles (e.g., clear toner).

After the latent image is developed into a visible image on the photoreceptor, a suitable receiver is brought into juxtaposition with the visible image. A suitable electric field is applied to transfer the toner particles of the visible image to the receiver to form the desired print image on the receiver. The imaging process is typically repeated many times with reusable photoreceptors. Alternatively, the visible image can be transferred from the photoreceptor to an intermediate member, and then to the receiver.

The receiver is then removed from its operative association with the photoreceptor or intermediate member and subjected to heat or pressure to permanently fix (“fuse”) the print image to the receiver. Plural print images, e.g., of separations of different colors, are overlaid on one receiver before fusing to form a multi-color print image on the receiver.

Electrophotographic (EP) printers typically transport the receiver past the photoreceptor to form the print image. The direction of travel of the receiver is referred to as the slow-scan, process, or in-track direction. This is typically the vertical (Y) direction of a portrait-oriented receiver. The direction perpendicular to the slow-scan direction is referred to as the fast-scan, cross-process, or cross-track direction, and is typically the horizontal (X) direction of a portrait-oriented receiver. “Scan” does not imply that any components are moving or scanning across the receiver; the terminology is conventional in the art.

Conventional color printers form multiple visible images, one for each color or separation, in register on an intermediate web (IW) member. All of the print images are then transferred simultaneously from the IW to a receiver. However, the IW experiences varying tension along its length due to friction at the mechanical contact point(s) with each photoreceptor. In printers that use compliant IWs, such as the KODAK NEXPRESS M700 press, the variations in tension can result in differential stretch of portions of the IW. This can result in stretching of one separation with respect to another, reducing registration and image quality. Additionally, as total drag on the IW increases, the energy required to drive the IW increases, and the drive components have to be made stronger and stiffer, and therefore heavier and more expensive. Some printers use a “pull” configuration in which photoreceptors are located along the span of IW from a tensioning roller to a drive motor in the direction of travel of the web. Other printers, such as the KODAK NEXPRESS M700 and XEROX PHASER 7500, use a “push” configuration in which photoreceptors are located along the span of IW from the drive motor to the tensioning roller in the direction of travel of the web.

U.S. Reissued Pat. No. RE 37,174 E describes various ways of tensioning belts, including adjusting the position of opposed members around which the belt is entrained, and adjusting the inflation of pneumatic entraining members. However, these schemes do not apply to a belt or IW with a large number of driven elements along its length.

U.S. Pat. No. 5,376,999 to Hwang describes drag rollers or skid plates pressed against the IW at selected points to reduce stretching and shrinking of the IW by counteracting the forces that distort the IW. However, this scheme directly increases the friction on the IW, and thus the energy required to drive it.

U.S. Pat. No. 5,940,668 to Tanigawa et al., in col. 11 et seq., describes transferring a visible image from a photoreceptor to an IW so that the photoreceptor is moving at a different speed than the IW when the transfer occurs. This improves transfer efficiency by providing a shearing force that helps remove toner from the photoreceptor. Tanigawa also discloses running the receiver faster than the IW and the photoreceptor slower than the IW to provide a shearing force in each case. Similarly, U.S. Pat. No. 6,226,465 to Funatani describes running the IW between 0.2% and 2% faster than the photoreceptor.

### SUMMARY OF THE INVENTION

However, in a multi-component color printer, running the photoreceptor slower than the IW at every station can result in excess tension on segments of the IW, since each photoreceptor drags on the IW. Similarly, running the photoreceptor faster than the IW at every station can result in the IW having slack segments, since each photoreceptor pushes the IW ahead of it. There is a need, therefore, for a way of operating a printer using an IW and multiple stations so that tension is kept more consistent and image quality is maintained.

According to an aspect of the present invention, therefore, there is provided a method of reducing drag on a rotatable web drive member for driving a web in an electrophotographic printer, comprising:

a. rotating the web drive member so that the web moves along a path;

b. arranging a plurality of rotatable, driven tensioning members spaced along the path so that each exerts a respective drag force on the web drive member through the web while maintaining tension on the web between adjacent members, wherein each tensioning member has a surface speed at a point of contact with the web; and

c. assigning the tensioning members to first and second groups so that each tensioning member in the first group is rotated with a greater surface speed than each member in the second group, so that members of the first group exert a negative drag and members of the second group exert a positive drag, and the total drag on the web drive member is less than the sum of the magnitudes of the respective drags exerted by the tensioning members.

According to another aspect of this invention, there is provided an electrophotographic printer, comprising:

a. a web and a rotatable web drive member that drives the web along a path at a selected linear speed;

b. five or more rotatable, driven tensioning members divided into two groups and spaced along the path so that each exerts a respective drag force on the web drive member through the web while maintaining tension on the web between adjacent members, wherein each tensioning member has a surface speed at a point of contact with the web; and

c. wherein each tensioning member in the first group is rotated with a greater surface speed than each member in the second group, so that members of the first group exert a negative drag and members of the second group exert a positive drag, the total drag on the web drive member is less than the sum of the magnitudes of the respective drags exerted by the tensioning members, and the surface speeds and the drag forces of the tensioning members are selected so that the web does not slip on the web drive member.

An advantage of this invention is that it provides more consistent tension around the intermediate web (IW) than prior systems, and therefore provides higher image quality. It does not require larger, more energy-consuming drive motors and stronger, more expensive drive components. It permits using an IW with a higher coefficient of friction (COF) for a given power of drive motor; some IW materials with higher COFs can provide improved transfer efficiency and thus image quality. In various embodiments, the velocities of different segments of the IW are kept consistent, reducing image artifacts due to mis-registration and IW stretch.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of an electrophotographic reproduction apparatus according to various embodiments;

FIGS. 2 and 3 show forces on a web in various embodiments;

FIG. 4 shows a cross-section of a compliant web according to various embodiments;

FIG. 5 shows a flowchart of a method of reducing drag on a rotatable web drive member for driving a web in an electrophotographic printer; and

FIG. 6 shows portions of an electrophotographic printer according to various embodiments.

The attached drawings are for purposes of illustration and are not necessarily to scale.

### DETAILED DESCRIPTION OF THE INVENTION

In the following description, some embodiments will be described in terms that would ordinarily be implemented as software programs. Those skilled in the art will readily recognize that the equivalent of such software can also be constructed in hardware. Given the systems and methods as described herein, software not specifically shown, suggested, or described herein that is useful for implementation of any embodiment is conventional and within the ordinary skill in such arts.

The electrophotographic process can be embodied in devices including printers, copiers, scanners, and facsimiles, and analog or digital devices, all of which are referred to herein as “printers.” Various aspects of the present invention are useful with electrostatographic printers such as electrophotographic printers that employ toner developed on an electrophotographic receiver, and ionographic printers and copiers that do not rely upon an electrophotographic receiver. Electrophotography and ionography are types of electrostatography (printing using electrostatic fields), which is a subset of electrography (printing using electric fields).

A digital reproduction printing system (“printer”) typically includes a digital front-end processor (DFE), a print engine (also referred to in the art as a “marking engine”) for applying toner to the receiver, and one or more post-printing finishing system(s) (e.g., a UV coating system, a glosser system, or a laminator system). A printer can reproduce pleasing black-and-white or color onto a receiver. A printer can also produce selected patterns of toner on a receiver, which patterns (e.g., surface textures) do not correspond directly to a visible image. The DFE receives input electronic files (such as Postscript command files) composed of images from other input devices (e.g., a scanner, a digital camera). The DFE can include various function processors, e.g., a raster image processor (RIP), image positioning processor, image manipulation processor, color processor, or image storage processor. The DFE rasterizes input electronic files into image bitmaps for the print engine to print. In some embodiments, the DFE permits a human operator to set up parameters such as layout, font, color, paper type, or post-finishing options. The print engine takes the rasterized image bitmap from the DFE and renders the bitmap into a form that can control the printing process from the exposure device to transferring the print image onto the receiver. The finishing system applies features such as protection, glossing, or binding to the prints. The finishing system can be implemented as an integral component of a printer, or as a separate machine through which prints are fed after they are printed.

The printer can also include a color management system which captures the characteristics of the image printing process implemented in the print engine (e.g., the electrophotographic process) to provide known, consistent color reproduction characteristics. The color management system can also provide known color reproduction for different inputs (e.g., digital camera images or film images).

In an embodiment of an electrophotographic modular printing machine useful with the present invention, e.g., the NEXPRESS 2100 printer manufactured by Eastman Kodak Company of Rochester, N.Y., color-toner print images are made in a plurality of color imaging modules arranged in tandem, and the print images are successively electrostatically transferred to a receiver adhered to a transport web moving through the modules. Colored toners include colorants, e.g., dyes or pigments, which absorb specific wavelengths of visible light. Commercial machines of this type typically employ intermediate transfer members in the respective modules for transferring visible images from the photoreceptor and transferring print images to the receiver. In other electrophotographic printers, each visible image is directly transferred to a receiver to form the corresponding print image.

Electrophotographic printers having the capability to also deposit clear toner using an additional imaging module are also known. The provision of a clear-toner overcoat to a color print is desirable for providing protection of the print from fingerprints and reducing certain visual artifacts. Clear toner uses particles that are similar to the toner particles of the color development stations but without colored material (e.g., dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective color toners are deposited one upon the other at respective locations on the receiver and the height of a respective color toner stack is the sum of the toner heights of each respective color. Uniform stack height provides the print with a more even or uniform gloss.

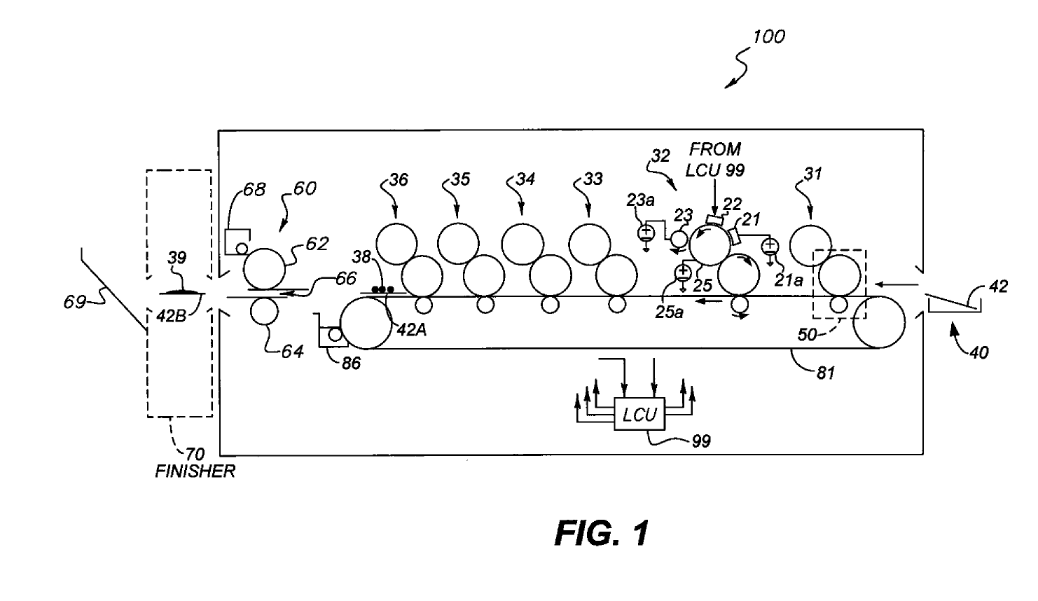

FIG. 1 is an elevational cross-sections showing portions of a typical electrophotographic printer 100 useful with the present invention. Printer 100 is adapted to produce images, such as single-color (monochrome), CMYK, or pentachrome (five-color) images, on a receiver (multicolor images are also known as “multi-component” images). Images can include text, graphics, photos, and other types of visual content. One embodiment of the invention involves printing using an electrophotographic print engine having five sets of single-color image-producing or -printing stations or modules arranged in tandem, but more or less than five colors can be combined on a single receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, 36, also known as electrophotographic imaging subsystems. Each printing module produces a single-color toner image for transfer using a respective transfer subsystem 50 (for clarity, only one is labeled) to a receiver 42 successively moved through the modules. Receiver 42 is transported from supply unit 40, which can include active feeding subsystems as known in the art, into printer 100. In various embodiments, the visible image can be transferred directly from an imaging roller to a receiver, or from an imaging roller to one or more transfer roller(s) or belt(s) in sequence in transfer subsystem 50, and thence to receiver 42. Receiver 42 is, for example, a selected section of a web of, or a cut sheet of, planar media such as paper or transparency film.

Each printing module 31, 32, 33, 34, 35, 36 includes various components. For clarity, these are only shown in printing module 32. Around photoreceptor 25 are arranged, ordered by the direction of rotation of photoreceptor 25, charger 21, exposure subsystem 22, and toning station 23.

In the EP process, an electrostatic latent image is formed on photoreceptor 25 by uniformly charging photoreceptor 25 and then discharging selected areas of the uniform charge to yield an electrostatic charge pattern corresponding to the desired image (a “latent image”). Charger 21 produces a uniform electrostatic charge on photoreceptor 25 or its surface. Exposure subsystem 22 selectively image-wise discharges photoreceptor 25 to produce a latent image. Exposure subsystem 22 can include a laser and raster optical scanner (ROS), one or more LEDs, or a linear LED array.

After the latent image is formed, charged toner particles are brought into the vicinity of photoreceptor 25 by toning station 23 and are attracted to the latent image to develop the latent image into a visible image. Note that the visible image may not be visible to the naked eye depending on the composition of the toner particles (e.g. clear toner). Toning station 23 can also be referred to as a development station. Toner can be applied to either the charged or discharged parts of the latent image.

After the latent image is developed into a visible image on the photoreceptor 25, a suitable receiver is brought into juxtaposition with the visible image. In transfer station 50, a suitable electric field is applied to transfer the toner particles of the visible image to the receiver 42 to form the desired print image on the receiver 42. The imaging process is typically repeated many times with reusable photoreceptors.

The receiver 42 is then removed from its operative association with the photoreceptor 25 and subjected to heat or pressure to permanently fix (“fuse”) the print image 38 to receiver 42A. Plural print images, e.g. of separations of different colors, are overlaid on one receiver before fusing to form a multi-color print image on the receiver.

Each receiver, during a single pass through the six modules, can have transferred in registration thereto up to six single-color toner images to form a pentachrome image. As used herein, the term “hexachrome” implies that in a print image, combinations of various of the six colors are combined to form other colors on the receiver at various locations on the receiver. That is, each of the six colors of toner can be combined with toner of one or more of the other colors at a particular location on the receiver to form a color different than the colors of the toners combined at that location. In an embodiment, printing module 31 forms black (K) print images, 32 forms yellow (Y) print images, 33 forms magenta (M) print images, 34 forms cyan (C) print images, 35 forms light-black (Lk) images, and 36 forms clear images.

In various embodiments, printing module 36 forms a print image using a clear toner or tinted toner. Tinted toners absorb less light than they transmit, but do contain pigments or dyes that move the hue of light passing through them towards the hue of the tint. For example, a blue-tinted toner coated on white paper will cause the white paper to appear light blue when viewed under white light, and will cause yellows printed under the blue-tinted toner to appear slightly greenish under white light.

Receiver 42A is shown after passing through printing module 36. Print image 38 on receiver 42A includes unfused toner particles.

Subsequent to transfer of the respective print images, overlaid in registration, one from each of the respective printing modules 31, 32, 33, 34, 35, 36, receiver 42A is advanced to a fuser 60, i.e. a fusing or fixing assembly, to fuse print image 38 to receiver 42A. Transport web 81 transports the print-image-carrying receivers to fuser 60, which fixes the toner particles to the respective receivers by the application of heat and pressure. The receivers are serially de-tacked from transport web 81 to permit them to feed cleanly into fuser 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

Fuser 60 includes a heated fusing roller 62 and an opposing pressure roller 64 that form a fusing nip 66 therebetween. In an embodiment, fuser 60 also includes a release fluid application substation 68 that applies release fluid, e.g. silicone oil, to fusing roller 62. Alternatively, wax-containing toner can be used without applying release fluid to fusing roller 62. Other embodiments of fusers, both contact and non-contact, can be employed with the present invention. For example, solvent fixing uses solvents to soften the toner particles so they bond with the receiver. Photoflash fusing uses short bursts of high-frequency electromagnetic radiation (e.g. ultraviolet light) to melt the toner. Radiant fixing uses lower-frequency electromagnetic radiation (e.g. infrared light) to more slowly melt the toner. Microwave fixing uses electromagnetic radiation in the microwave range to heat the receivers (primarily), thereby causing the toner particles to melt by heat conduction, so that the toner is fixed to the receiver.

The receivers (e.g. receiver 42B) carrying the fused image (e.g., fused image 39) are transported in a series from the fuser 60 along a path either to a remote output tray 69, or back to printing modules 31, 32, 33, 34, 35, 36 to create an image on the backside of the receiver, i.e. to form a duplex print. Receivers can also be transported to any suitable output accessory. For example, an auxiliary fuser or glossing assembly can provide a clear-toner overcoat. Printer 100 can also include multiple fusers 60 to support applications such as overprinting, as known in the art.

In various embodiments, between fuser 60 and output tray 69, receiver 42B passes through finisher 70. Finisher 70 performs various media-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), programmable logic controller (PLC) (with a program in, e.g., ladder logic), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fuser 60 for receivers. This permits printer 100 to print on receivers of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), cyan (C), and red (R), respectively. The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer. The RIP can perform image processing processes, e.g. color correction, in order to obtain the desired color print. Color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Various parameters of the components of a printing module (e.g., printing module 31) can be selected to control the operation of printer 100. In an embodiment, charger 21 is a corona charger including a grid between the corona wires (not shown) and photoreceptor 25. Voltage source 21a applies a voltage to the grid to control charging of photoreceptor 25. In an embodiment, a voltage bias is applied to toning station 23 by voltage source 23a to control the electric field, and thus the rate of toner transfer, from toning station 23 to photoreceptor 25. In an embodiment, a voltage is applied to a conductive base layer of photoreceptor 25 by voltage source 25a before development, that is, before toner is applied to photoreceptor 25 by toning station 23. The applied voltage can be zero; the base layer can be grounded. This also provides control over the rate of toner deposition during development. In an embodiment, the exposure applied by exposure subsystem 22 to photoreceptor 25 is controlled by LCU 99 to produce a latent image corresponding to the desired print image. All of these parameters can be changed, as described below.

Further details regarding printer 100 are provided in U.S. Pat. No. 6,608,641, issued on Aug. 19, 2003, to Peter S. Alexandrovich et al., and in U.S. Publication No. 2006/0133870, published on Jun. 22, 2006, by Yee S. Ng et al., the disclosures of which are incorporated herein by reference.

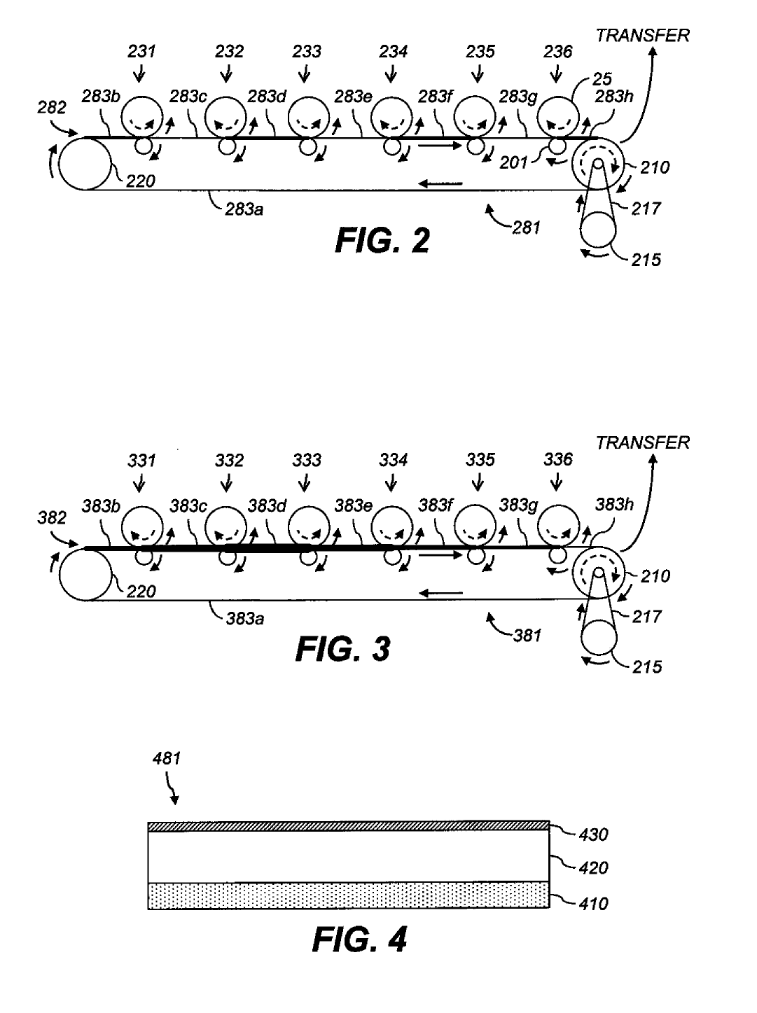

FIG. 2 shows forces on a web in various embodiments. Solid arrows indicate motion and dashed arrows represent forces, as described below.

The thicknesses of segments of web 281 represent the tensions of those segments; thicker segments represent higher tension. Printing modules 231, 232, 233, 234, 235, 236 each include a respective photoreceptor 25 and transfer backup roller 201 (for clarity, not shown on printing modules 232-236). Web 281, which can be an intermediate web (IW), receives visible images in register from the respective photoreceptors (e.g., 25) of printing modules 231, 232, 233, 234, 235, 236 and transfers them to a receiver (not shown) at the arrow labeled “TRANSFER.” Web 281 is compliant; it can stretch and shrink within its mechanical limits, as discussed below (non-compliant belts can also be used). Drive roller 210 is driven by motor 215 through belt 217 to move web 281. Other drive configurations, such as direct, geared, or chain drive, can also be used. Tensioning roller 220 sets the baseline tension of web 281.

In FIG. 2, dashed arrows represent forces. “Positive drag” refers to a force on web 281 opposite the force applied to web 281 by drive roller 210. “Negative drag” refers to a force on web 281 in the same direction as the force applied to web 281 by drive roller 210.

Drive roller 210 pulls upper span 282 of web 281 from left to right. Tensioning roller 220 is positioned to keep upper span 282 under a baseline amount of tension. Tensioning roller 220 can also be braked or driven to change the force on web 281 from tensioning roller 220.

Web cleaners (not shown), such as skives, wipers, fur-brush roller cleaners, magnetic-brush roller cleaners, and vacuum cleaners can be used and will apply positive drag to web 281.

In this embodiment, the respective photoreceptor 25 in each printing module 231, 233, and 235 is overdriven. That is, each photoreceptor 25 has a surface speed at the point of contact with web 281 that is greater than the linear speed of web 281. The surface speed is the linear velocity tangent to photoreceptor 25 of the surface of photoreceptor 25 at the point of contact between photoreceptor 25 and web 281. The photoreceptors 25 in printing modules 232, 234, and 236 are underdriven. That is, these photoreceptors have a lower surface speed than the linear speed of web 281. Each therefore pulls upper span 282 to the left. That is, the force applied to web 281 by the photoreceptors in printing modules 231, 232 is in the opposite direction along the web as the force applied to web 381 by drive roller 210. This condition is referred to as “underdrive” or positive drag. Note that an undriven member in contact with web 281 would exert a small positive drag corresponding to the friction forces between that member and web 281.

The photoreceptors can be driven by one or motor(s) directly or through belts, chains, or gears (not shown). Therefore, each photoreceptor 25 pulls upper span 282 to the right. The force applied to web 281 by each photoreceptor 25 is in the same direction along the web as the force applied to web 281 by drive roller 210, so this condition is referred to as “overdrive” or negative drag.

Web 281 includes a plurality of tensioned segments. Each driven member in contact with web 281, except drive roller 210, is a tensioning member. Photoreceptors 25 and tensioning roller 220 are all tensioning members. A plurality of tensioned segments of the web are defined between adjacent members, either drive members, e.g., drive roller 210, or tensioning members. Web 281 has tensioned segments 283a (between drive roller 210 and tensioning roller 220), 283b (between tensioning roller 220 and the photoreceptor of printing module 231, hereinafter between tensioning roller 220 and printing module 231), 283c (between printing modules 231, 232), 283d (between printing modules 232, 233), 283e (between printing modules 233, 234), 283f (between printing modules 234, 235), 283g (between printing modules 235, 236), and 283h (between printing module 236 and drive roller 220).

In some conventional systems, all the members in contact with a web are overdriven. In such a system, each tensioned segment of such a web would have successively lower tension from as it passed each tensioning member in turn. If too many tensioning members were present, or the overdrive were too strong on one or more of them, the web would go slack at some point, as tension dropped to zero. In other conventional systems, all the members in contact with a web are underdriven. If too many tensioning members were present, or the underdrive were too strong on one or more of them, the drive member would stall, or the belt would slip on the drive member. This would result in poor image quality or failure to print.

In FIG. 2, the tensions on the segments are represented graphically by the thicknesses of the tensioned segments 283a-h. In these embodiments, unlike conventional systems, the tension increases and decreases as the web travels. Representing the tension on segment 283x as Tₓ, for x in a-h, T_{b}>T_{c}; T_{d}>Tₑ; T_{f}>T_{g}; and Tₕ>Tₐ. Likewise, T_{c}<T_{d}; Tₑ<T_{f}; and T_{g}<Tₕ. In other embodiments, Tₕ can be greater than, less than, or equal to Tₐ.

Controlling the tension in the tensioned segments provides a number of advantages. A significant difference in tension across drive roller 210 can results in the drive roller's slipping with respect to web 281, causing a partial or total loss of web drive capability. If the tensions on tensioned segments 283h and 283a are too high, motor 215 can stall (e.g., using a stepper, or using a DC motor if the tension is very high) or slow down (e.g. using a non-regulated DC motor 215). In a servo system, a significant slowdown leads to very high P and I error terms, which can result in an unrecoverable fault.

Controlling the drag forces applied by the tensioning members permits control of the tensions of the tensioned segments. Controlling those tensions permits control of the local speed of web 281 in each tensioned segment. Tensions and velocities can therefore be selected to provide a balanced system, in which no one motor or other drive component bears significantly more load than any other.

Controlling local web speed provides improved registration without requiring manual timing adjustments or calibration systems. In an embodiment, web velocity is measured using sensors on each segment, or by interpolating encoder readings of angular velocity of tensioning members adjacent to each segment using the known diameters of those members. The drive of each tensioning member is adjusted to provide respective web velocities of each segment within ±0.03%, or ±0.3%, or ±1%. A tolerance of ±0.03% provides a registration error of approximately ±0.003″ over an 11″ image. This amount of registration error can be non-objectionable to the user.

The term “upper span” does not limit the orientation of web 281 or components arranged around web 281. In the embodiment shown here, photoreceptors 25 are arranged between tensioning roller 220 and drive roller 210 in the direction of travel of web 281. That is, the drive roller 210 pulls web 281 through printing modules 231-236. In other embodiments, one or more photoreceptors 25, or other elements providing positive or negative drags, can be arranged between drive roller 210 and tensioning roller 220 in the direction of travel of web 281. That is, drive roller 210 can push web 281 through printing modules or other electrophotographic or other elements.

FIG. 3 shows forces on a web in another embodiment. Drive roller 210, tensioning roller 220, motor 215, and belt 217 are as shown in FIG. 2. Printing modules 331, 332, 333, 334, 335, 336 are each as described above, but driven differently. Web 381 has upper span 382, and has tensioned segments 383a, 383b, 383c, 383d, 383e, 383f, 383g, 383h, starting from drive roller 210 and moving clockwise. Printing modules 331 and 332 are underdriven. Printing modules 333, 334, 335, 336 are overdriven.

As a result, tensioned segment 383d, between printing modules 332, 333, has the highest tension. The tension relationships are
T_{d}>Tₑ>T_{f}>T_{g}>Tₕ and
T_{d}>T_{c}>T_{b}>Tₐ.
   In an embodiment, Tₕ>Tₐ. In other embodiments, Tₕ can be equal to, or less than, Tₐ. The tension relationships depend on the number and arrangement of tensioning members, and their division into groups.

FIG. 4 shows a cross-section of a compliant web according to various embodiments. Web 481 includes a base layer 410, a compliant layer 420, and a release layer 430 affixed together. Base layer 410 can be a glassy material, such as polyamide, polyimide, PET, or polycarbonate. Base layer 410 can also be metal, e.g., a single layer of steel. Base layer 410 is 70 μm-100 μm thick, preferably 83 μm. It has a Young's modulus of above 2000 MPa, approximately 4000 MPa, or above 50 GPa (for metal). Compliant layer 420 is a polyurethane. It is at least 200 μm thick, and has a Young's modulus of between 1 MPa and 100 MPa, preferably approximately 4 MPa. Release layer 430 is a ceramer, e.g., a ceramic in a polyurethane matrix. It is approximately 4 μm thick and has a Young's modulus of approximately 400 MPa.

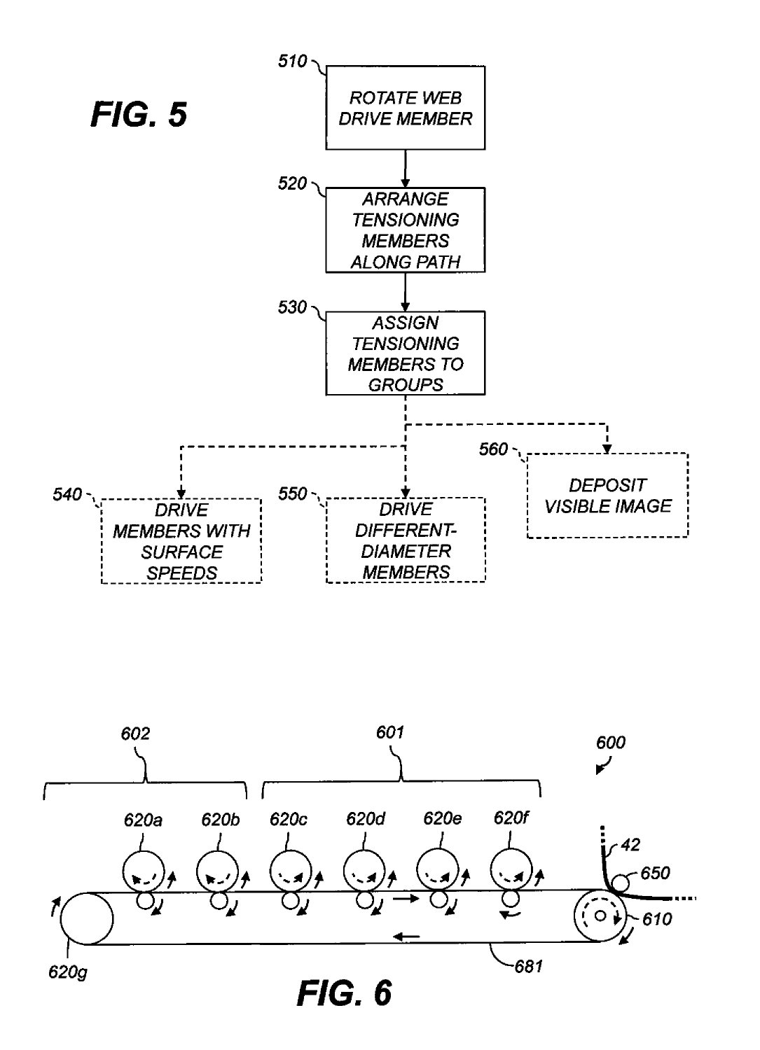

FIG. 5 shows a flowchart of a method of reducing drag on a rotatable web drive member (e.g., drive roller 210, FIG. 2) for driving a web (e.g., web 281, FIG. 2) in an electrophotographic printer. The web can be media, e.g. un-cut paper, an intermediate web as discussed above, or a web photoconductor.

Processing begins with step 510. In step 510, the web drive member is rotated so that the web moves along a path. The web moves with a selected linear speed, determined by the speed of the web drive member. In an embodiment, the respective average linear speed of each segment along the whole web varies by less than ±0.003%. Step 510 is followed by step 520.

In step 520, a plurality of rotatable, driven tensioning members (e.g., photoreceptors 25, FIG. 2) are arranged spaced along the path of the web. Each tensioning member is arranged to exert a respective drag force on the web drive member through the web while maintaining tension on the web between adjacent members (tensioning or drive). Each tensioning member has a surface speed at a point of contact with the web. Each tensioning member can be a web, a roller, or another type of member having a surface speed at the contact point. Step 520 is followed by step 530.

In step 530, the tensioning members are assigned to first and second groups. That is, each tensioning member is assigned to either the first group or the second group. Each tensioning member in the first group is rotated with a greater surface speed than each member in the second group. Members of the first group exert a negative drag, i.e., an overdrive, on the web. Members of the second group exert a positive drag, i.e., an underdrive, on the web. The total drag on the web drive member is less than the sum of the magnitudes (i.e., amount without regard to direction) of the respective drags exerted by the tensioning members.

In an example, referring also to FIG. 3, the web drive member is drive roller 210. The tensioning members are photoreceptors 25 (FIG. 2) in printing modules 231, 232, 233, 234, 235, 236, and also tensioning roller 220. The first group, the overdriven tensioning members, includes the photoreceptors in printing modules 333, 334, 335, and 336. The second group, the underdriven tensioning members, includes tensioning roller 220 and the photoreceptors in printing modules 331 and 332.

In various embodiments, step 530 is followed by step 540, step 550, or step 560.

In various embodiments, in step 540, each tensioning member in the first group is driven so that its surface speed is greater than the linear speed of the web. Each tensioning member in the second group is driven so that its surface speed is less than the linear speed of the web. This provides effective over- and under-drive using controllable motors, such as servomotors. In various embodiments, the rotational speed of each tensioning member in the first group is greater than the rotational speed of any tensioning member in the second group.

In various embodiments, in step 550, each tensioning member is cylindrical, and each member of the first group has a greater diameter than each member of the second group. This permits a single motor to be used to drive more than one tensioning member at constant angular velocity. The larger diameter of the members in the first group gives them a higher surface speed than the members in the second group. The diameters and motor drive velocity or velocities are selected so that the surface speed of members of the first group is greater than the linear speed of the web, and the surface speed of members in the second group is less than the linear speed of the web, as described above.

In various embodiments, each tensioning member is driven at a selected angular velocity, e.g., with an average angular velocity within ±0.003% of the selected angular velocity. This velocity defines a reference diameter at which a tensioning member driven at the selected angular velocity would have a surface speed equal to the linear speed of the web. Each tensioning member in the first group is provided with a smaller diameter than the reference diameter, so that its linear speed is less than the linear speed of the web. Each tensioning member in the second group is provided with a larger diameter than the reference diameter, so that its linear speed is greater than the linear speed of the web. In various embodiments, the tensioning members have diameters between 30 mm and 100 mm, e.g., 60 mm.

In an embodiment, one tensioning member is a photoconductor with a diameter of 30 mm. One toning station is adjacent to this photoreceptor. Another tensioning member is a photoconductor with a diameter of 100 mm, with two toning stations adjacent thereto. The speed and diameter of both photoreceptors are selected to provide a desired overdrive or underdrive.

In various embodiments, in step 560, a visible image is deposited on the web using one of the tensioning members while the web drive member rotates. In some embodiments, the web is an intermediate web (IW), as discussed above. One or more of the tensioning members are photoreceptors or other intermediates that deposit respective visible image(s) on the web.

In various embodiments, the tension on any portion of the web is not less than a selected tension. In other embodiments, the tension on any portion of the web can be greater than, less than, or equal to the selected tension. Referring back to FIG. 3, in embodiments, tensioning roller 220 and drive roller 210 determine the selected tension as the tension on segment 383a, and all segments in upper span 382 have tension greater than or equal to the tension on segment 383a. In this way, the web does not go slack at any point along its length. In various embodiments, the tension on each tensioned segment of the web is positive.

In various embodiments, the total drag on the web drive member exceeds a selected threshold, so that the web does not slip on the web drive member. The threshold is selected considering the tension(s) of the web along its length and the coefficient of friction between the web and the web drive member.

As discussed above, in various embodiments, at least one of the tensioning members is an imaging member. Imaging members can include photoreceptors, blanket cylinders with compliant surfaces, intermediate cylinders or webs, or other rollers involved in transferring a visible image on the web to a receiver.

FIG. 6 shows portions of electrophotographic printer 600 according to various embodiments, in elevational cross-section. Web 681 is driven along a path at a selected linear speed by rotatable web drive member 610. Tolerances are as given above. Solid arrows indicate motion and dashed arrows represent forces, as discussed above with reference to FIG. 2. Other portions not shown in FIG. 6 are as printer 100 shown in FIG. 1.

Five or more rotatable, driven tensioning members 620a, 620b, 620c, 620d, 620e, 620f, 620g are divided into two groups, first group 601 and second group 602. Each tensioning member 620a-h can be a roller or web; for example, a web photoconductor and web intermediate can be used. Tensioning members 620a-h are spaced along the path of web 681 so that each exerts a respective drag force on web drive member 610 through web 681 while maintaining tension on web 681 between adjacent members (either drive or tensioning). Each tensioning member 620a-h has a surface speed at a point of contact with web 681. In an embodiment, web 681 is an intermediate, tensioning members 620a-f are photoreceptors, and the visible image on web 681 is transferred to receiver 42 to form a print image at a transfer nip formed between web drive member 610 and transfer backup member 650. .

Each tensioning member 620c-f in first group 601 is rotated with a greater surface speed than each member 620a, b, g in second group 602. Members of first group 601 thus exert a negative drag (overdrive) on web 681. Members of second group 602 exert a positive drag (underdrive). The total drag on web drive member 610 is less than the sum of the magnitudes of the respective drags exerted by tensioning members 620a-g. Moreover, the surface speeds and the drag forces of tensioning members 620a-g are selected so that web 681 does not slip on web drive member 610. The drag exerted on the web by any tensioning member is a function of the coefficient of friction (COF) between the web and the member, and the force between the web and the member normal to the member at the point of contact. For imaging members, the COF is determined when materials are selected for the web and member to provide desired toner transfer characteristics. Transfer properties and COF can also be co-optimized in the selection of materials, that is, materials can be selected to provide acceptable transfer properties and acceptable COF. Once materials are selected, a mechanical design is performed and forces are simulated to determine which segments' tensions need to be adjusted. The system is adjusted to reduce motor torque on the drive roller with permitting slippage. The motor torque is sufficiently high to keep the entire web positively driven, so that the drive member is always driving the web and not driven by the web.

This will result in web drive member 610 having a surface speed substantially equal to the linear speed of web 681 (tolerances are as given above). That is, web drive member 610 is not slipping on web 681 (not enough tension) or stalling (too much tension). The linear speed of the web matches a selected linear speed (tolerances are as given above). That is, there is not so much tension that web drive member 610 cannot drive web 681 at the selected linear speed.

In various embodiments, as discussed above, the tension on any portion of the web is not less than a selected tension. In other embodiments, the tension can be greater than, less than, or equal to the selected tension. In various embodiments, the total drag on web drive member 610 exceeds a selected threshold, so that web 681 does not slip on web drive member 610. In various embodiments, one or more of the tensioning members 620a-g is an imaging member, e.g., a photoreceptor or intermediate.

In various embodiments, web drive member 610 includes a straight voltage or current source, or a servo, for providing motive power. Web drive member 610 can include one or more sensors so that web 681 is driven to maintain a selected linear speed and experience a selected baseline tension.

LCU 99 (FIG. 1) can be provided with a selected linear speed as input. Sensors (e.g., encoders) can be used to measure the speed and torque of the web drive member and the tensioning members to cause each tensioning member to exert either a non-negative or a negative drag, so that the respective tension on each tensioned segment is >0, the total drag on the web drive member is less than the sum of the magnitudes of the respective drags exerted by the tensioning members, the surface speed of the web drive member is the same as the linear speed of the web (tolerances are as given above). That is, some element of the web is in positive, non-slipping contact with the facing portion of the web drive member at any given time, and the web drive member is not stalled. The linear speed of the web is substantially the same as a selected linear speed (too much drag can cause web 681 to slow down). Sensors can also measure the tensions of individual tensioned segments of web 681 and provide that information to LCU 99.

In various embodiments, the tensions and local speeds of the tensioned segments of web 681 are determined before production begins on a particular model of printer, and all printers are manufactured to have the same tensions and speeds (within tolerances). In other embodiments, the tensions and local speeds are determined at the time of print job setup, or in real time, based on the paper thickness, toner size (e.g., mean toner diameter), and environmental conditions around the printer (e.g., temperature and humidity), component life remaining (e.g., for photoreceptors, rollers, and heaters). LCU 99 (FIG. 1) automatically determines the angular velocities of the tensioning members to provide the correct over- and under-drive for the conditions of each particular print job. LCU 99 uses the known mechanical configuration of the printer and COF of the web to estimate the drag forces from each tensioning member, and selects tensioning-member speeds so that the web drive member always drives the web, as described above. In various embodiments, LCU 99 includes a non-linear optimization routine to determine the preferred tensioning-member speeds to provide desired tensions.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

21 charger
21a voltage source
22 exposure subsystem
23 toning station
23a voltage source
25 photoreceptor
25a voltage source
31, 32, 33, 34, 35 printing module
38 print image
39 fused image
30 supply unit
42, 42A, 42B receiver
50 transfer subsystem
60 fuser
62 fusing roller
64 pressure roller
66 fusing nip
68 release fluid application substation
69 output tray
70 finisher
81 transport web
86 cleaning station
99 logic and control unit (LCU)
100 printer
201 transfer backup roller
210 drive roller
215 motor
217 belt
220 tensioning roller
231, 232, 233, 234, 235, 236 printing module
281 web
282 upper span
283a, 283b, 283c, 283d, 283e, 283f, 283g, 283h tensioned segment
331, 332, 333, 334, 335, 336 printing module
381 web
382 upper span
383a, 383b, 383c, 383d, 383e, 383f, 383g, 383h tensioned segment
410 base layer
420 compliant layer
430 release layer
481 web
510 rotate web drive member step
520 arrange tensioning members along path step
530 assign tensioning members to groups step
540 drive members with surface speeds step
550 drive different-diameter members step
560 deposit visible image step
600 electrophotographic printer
601 first group
602 second group
610 web drive member
620a, 620b, 620c, 620d, 620e, 620f, 620g tensioning member
650 transfer backup member

1. Method of reducing drag on a rotatable web drive member for driving a web in an electrophotographic printer, comprising:
a. rotating the web drive member so that the web moves along a path;
b. arranging a plurality of rotatable, driven tensioning members spaced along the path so that each exerts a respective drag force on the web drive member through the web while maintaining tension on the web between adjacent members, wherein each tensioning member has a surface speed at a point of contact with the web; and
c. assigning the tensioning members to first and second groups so that each tensioning member in the first group is rotated with a greater surface speed than each member in the second group, so that members of the first group exert a negative drag and members of the second group exert a positive drag, and the total drag on the web drive member is less than the sum of the magnitudes of the respective drags exerted by the tensioning members.

2. The method according to claim 1, wherein each tensioning member in the first group is driven so that its surface speed is greater than the linear speed of the web, and each tensioning member in the second group is driven so that its surface speed is less than the linear speed of the web.

3. The method according to claim 1, wherein each tensioning member is cylindrical, and each member of the first group has a greater diameter than each member of the second group.

4. The method according to claim 1, wherein the tension on any portion of the web is not less than a selected tension.

5. The method according to claim 1, wherein the total drag on the web drive member exceeds a selected threshold, so that the web does not slip on the web drive member.

6. The method according to claim 1, wherein one of the tensioning members is an imaging member

7. The method according to claim 1, further comprising depositing a visible image on the web using one of the tensioning members while the web drive member rotates.

9. The method according to claim 1, wherein the web includes a compliant layer having a Young's modulus between 1 MPa and 100 MPa.

10. The method according to claim 1, wherein the web includes a base layer having a Young's modulus above 2 GPa, or above 50 GPa.

11. An electrophotographic printer, comprising:
a. a web and a rotatable web drive member that drives the web along a path at a selected linear speed;
b. five or more rotatable, driven tensioning members divided into two groups and spaced along the path so that each exerts a respective drag force on the web drive member through the web while maintaining tension on the web between adjacent members, wherein each tensioning member has a surface speed at a point of contact with the web; and
c. wherein each tensioning member in the first group is rotated with a greater surface speed than each member in the second group, so that members of the first group exert a negative drag and members of the second group exert a positive drag, the total drag on the web drive member is less than the sum of the magnitudes of the respective drags exerted by the tensioning members, and the surface speeds and the drag forces of the tensioning members are selected so that the web does not slip on the web drive member.

12. The printer according to claim 11, wherein the tension on any portion of the web is not less than a selected tension.

13. The printer according to claim 11, wherein the total drag on the web drive member exceeds a selected threshold, so that the web does not slip on the web drive member.

14. The printer according to claim 11, wherein one of the tensioning members is an imaging member
